(19) United States
(12) Patent Application Publication
(10) Pub. No.: US 2002/0051529 A1
(43) Pub. Date: May 2, 2002

(54) Method for managing signal network including a mixed message transfer part signal point

(75) Inventor: Seung-hee Yi, Gunpo-si (KR)

Correspondence Address: FLESHNER & KIM, LLP, P.O. Box 221200, Chantilly, VA, 20153-1200, US

(73) Assignee: LG Electronics Inc.

(21) Appl. No.: 09/984,320

(22) Filed: Oct. 29, 2001

(30) Foreign Application Priority Data
Oct. 30, 2000 (KR) 2000-63989

(51) Int. Cl. H04M 7/00

(52) U.S. Cl. 379/230

(57) ABSTRACT

The present invention relates to a method for managing the signal network including a mixed message transfer part (MTP) signal point. Information concerning the message size that each signal point may process is provided to other signaling points on the network. If a message size is larger than the maximum message size that can be processed, the message is segmented before transmission. Consequently, signal message abandonment caused by the limitation on the message size is avoided, thereby enhancing the reliability and effectiveness of the signal network.

### BACKGROUND OF THE INVENTION

1. Field of the Invention

The present invention relates to a common channel signaling network, and more particularly to a method for managing a signal network including a mixed message transfer part (“MTP”) signal point.

2. Background of the Related Art

A No. 7 Signaling Method is a common channel signaling method standardized by the telecommunication standardization unit of the International Telecommunication Union (“ITU-T”). The No. 7 signaling method is used to transmit various control signals for network subscribers' connection with each other, so as to provide diverse telecommunication services or to operate and manage the telecommunication network.

FIG. 1 illustrates a related art No. 7 signaling network structure. As shown in FIG. 1, the No. 7 signaling network includes a message transfer part (“MTP”) 1 and a signal connection control part (“SCCP”) 2, which are network service parts in charge of the control of signal transmission, error correction, and network security. The network further includes an ISDN user part (“ISUP”) 3, a transaction capabilities part (“TCAP”) 4, and a telephone user part (“TUP”) 5, which are user parts individually designed in accordance with various application areas such as telephone switching, data switching, and so forth. Additionally, the No. 7 signaling network structure includes mobile telecommunication and intelligent network user parts (not shown in the drawing).

The MTP 1 transfers signal messages transmitted and received between signal points of the No. 7 signaling network. As illustrated in FIG. 2, the MTP includes a signal message handling module 20 and a signal network management module 10. The signal message handling module 20 conducts signal traffic transfer and user part distribution functions. The signal network management module 10 maintains the consistency in the relevant network resources and manages the network, using all of the resources included in the network, so as to provide for reliable message transmission. The resources used by the signal network management module 10 include the signal link, signal link set, signal points, and signal routes.

Furthermore, the MTP 1 uses signal links exclusively for transferring various control signals. The control signals on the signal links are distinguished from general telecommunication lines for voice or data. Consequently, the signal processing speed has been improved. Various signal contents regarding sender subscribers and receiver subscribers may be processed as signal units. The length of the relevant signal units may be varied according to the size of the corresponding data.

The MTP signal message transfer methods are provided in No. 7 signal standard and ITU-T Q.70× recommendations, published in North America. These two recommendations differ from each other only slightly and mostly include similar contents.

Because narrowband signal points and broadband signal points process data with different sizes, data is ordinarily transmitted via a mixed MTP signal point on the No. 7 signaling network. Such methods to transmit data between broadband signal points and narrowband signal points via a mixed MTP signal point are discussed in U.S. Pat. Nos. 5,953,404 and 6,222,843.

FIG. 3 is a diagram illustrating the general structure of a No. 7 signal network including narrowband signal points and broadband signal points connected with each other.

As shown in FIG. 3, the message transfer between narrowband signal points A, B, C and broadband signal points E, F, G is conducted using a mixed MTP signal point D. The message transfer between the narrowband signal points and the broadband signal points must be conducted using the mixed MTP signal point D because the physical interfaces of the narrowband signal points and the broadband signal points are different from each other. The mixed MTP signal point D thus provides an interface between the two different signal points.

FIG. 4 is a diagram illustrating the internal protocol structure of a narrowband signal point.

As shown in FIG. 4, the internal protocol structure of the narrowband signal point includes the MTP user part including the telephone user part 41, the ISDN user part 42 and the signal connection control part (SCCP) 44. The structure further includes the signal connection control user part including the transaction user part 43, and the MTP. The MTP is made up of MTP levels 1, 2 and 3.

FIG. 5 is a diagram illustrating the internal protocol structure of a broadband signal point. As shown in FIG. 5, the broadband signal point has the same MTP user part and signal connection control user part as the narrowband signal point. The physical layers at the MTP of the broadband signal point, however, are different from those of the narrowband signal point. The MTP physical layers of the broadband signal point include an asynchronous transmission mode, a signaling asynchronous transmission mode adaptation layer, and a broadband MTP level 3.

FIG. 6 is a diagram illustrating the internal protocol structure of a mixed MTP signal point. As shown in FIG. 6, the mixed MTP signal point has the same MTP user part and signal connection control user part as both the narrowband signal point and the wideband signal point. The physical layers at the MTP, however, includes the physical layers of both the narrowband signal point and the broadband signal point. Thus, in order to transfer messages between a narrowband signal point and a broadband signal point, messages must pass through the mixed MTP signal point.

FIG. 7 illustrates the signal path of a mixed MTP signal point through which messages are transferred between a narrowband signal point and a broadband signal point. As shown in FIG. 7, in order for a message to be transferred from a narrowband signal point to a broadband signal point, the signal message is transferred from the narrowband signal point to the mixed MTP signal point through the functions of MTP levels 1 to 3. The mixed MTP signal point thus receives the signal message through its MTP levels 1 and 2, which are used for the connection with the narrowband signal point. The mixed MTP signal point then transfers the signal message to the broadband signal point through the asynchronous transmission mode (ATM) and the signaling asynchronous transmission mode adaptation layer (SAAL), which are used for the connection with the broadband signal point. The broadband signal point receives the signal message through the asynchronous transmission mode and the signaling asynchronous transmission mode adaptation layer. The signal message transfer from the broadband signal point to the narrowband signal point is conducted in the reverse order of the above-described method.

The related art signal network management method has numerous problems. For example, the size of messages that may be processed by narrowband signal points differs from the size of messages that may be processed by broadband signal points. Generally, the maximum message size for a broadband signal point is 4096-octect. In contrast, the maximum message size for a narrowband signal point is 272-octet. Thus, there is a large difference in the message processing capacities of these two types of signal points.

Notwithstanding such capacity differences, the current MTP protocol does not have the function of segmenting/integrating the signal message. Therefore, if a message is transferred from a broadband signal point to a narrowband signal point without any particular measure, certain signal messages may be abandoned due to the restrictions in the message size.

Moreover, the related art No. 7 signal network management method does not provide a function of transferring information on the maximum signal message size within the signal network or to the MTP user part. Although the MTP user part has the capability of supporting the message segment/integration function, such function may not be used appropriately because the related art method does not provide the function of transmitting the maximum signal message size information.

Additionally, problems occur not only in transferring messages between a narrowband signal point and a broadband signal point, but also occur when transferring messages from a broadband signal point to another broadband signal point. Thus, the above-mentioned problems may arise because the maximum message size for each broadband signal point may be different.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

It is another object of the present invention to provide a method for managing a signal network in which signal messages may be exchanged between narrowband signal points and broadband signal points having different maximum message sizes.

It is another object of the present invention to provide a signal network management method for transmitting messages between a broadband signal point and a narrowband signal point without losing any signal messages.

It is another object of the present invention to enable the maximum signal message size to be transferred between different types of signal points within a signal network.

It is another object of the present invention to modify the signal network management message and the signal point information primitive to provide for transmission of messages between signaling points that have different maximum message sizes.

It is another object of the present invention to provide a method of transmitting messages from the MTP user part to the destination signal point after determining whether to segment the messages based upon maximum signal message size information.

In order to achieve at least the above objects in whole or in parts, there is provided a method for managing a signal network having a mixed MTP signal point by including in the signal network management message the information on the maximum message size that a signal point may process, and transmitting messages based upon the maximum message size information regarding the signal point to which the messages are to be transmitted. The signal network management message is preferably a message allowing at least one of the transfer (“transfer allowed” message) and the signal traffic restart (“traffic restart allowed” message).

The “transfer allowed” message preferably includes the routing label parameter containing the message sender/receiver signal point information, the heading code parameter distinguishing the signal message, the signal point parameter indicating the information on the signal point to which the message transfer is allowed, and the parameter indicating the maximum message size that may be processed.

The “traffic restart allowed” message preferably includes the routing label parameter containing the message sender/receiver signal point information, the heading code parameter distinguishing the signal message, the signal point parameter indicating the information on the signal point to which the message traffic restart is allowed, and the parameter indicating the maximum message size that may be processed.

In order to achieve at least the above objects, in whole or in parts, there is further provided a method to notify related signal points of the maximum message size that may be processed, including the steps of including in the signal point management message the information on the maximum message size that a signal point may process and transmitting it to other signal points' MTPs; and transmitting the maximum message size information included in the said transmitted message to the MTP user parts. When transmitting the maximum message size information from the MTP to the MTP user part, the maximum message size information is preferably transmitted as included in the signal point information primitive. Additionally, the received maximum message size information can preferably be stored in the MTP's database, and in the database of the MTP's user part.

The signal network management message is preferably transmitted to the related signal points whenever the maximum message size that can be processed is changed. Also, if more than one signal route have been established, the determination of the maximum message size is preferably made based upon the maximum message size of a signal route that has the smallest message processing capacity among the various signal routes.

In order to achieve at least the above objects in whole or in parts, there is further provided a method of comparing the maximum message size determined through the above-described manner and the size of the message to be transmitted, and segmenting the message to be transmitted in the event that the size of the message to be transmitted is larger than the maximum message size.

The step of comparing the message size and segmenting the message preferably includes comparing the maximum message size of the relevant signal point and the size of the message to be transmitted, requesting the message transmission from the MTP user part to the MTP in the event that the size of the message to be transmitted is smaller than the relevant signal point's maximum message size, segmenting the message to be transmitted at the said MTP user part in the event that the size of the message to be transmitted is larger than the relevant signal point's maximum message size, and requesting the transmission of the said segmented message from the said MTP user part to the said MTP. The request for the message transfer from the MTP user part to the MTP is preferably made by transmitting a MTP message transfer request primitive.

In order to further achieve at least the above objects, in whole or in parts, there is provided a method, including (a) including, in the signal network management message, information concerning the maximum message size that the relevant signal point may process and transmitting the signal network management message to other related signal points; (b) when the MTP receives the signal network management message transmitted in the said step (a), based upon the said received message, including the maximum message size information in the signal point availabilty information primitive and transmitting the said signal point availability information primitive to the MTP user part; (c) determining whether a specific signal point is available for the message transmission based upon the signal point availability information primitive received in the said step (b) and comparing the maximum message size of the said specific signal point and the size of the message to be transmitted; (d) in the event that the size of the message to be transmitted is smaller than the said specific signal point's maximum message size in the said step (c), requesting the message transmission by transmitting the message transfer request primitive to the MTP; and (e) in the event that the size of the message to be transmitted is larger than the said specific signal point's maximum message size in the said step (c), segmenting the message to be transmitted at the MTP user part and requesting the transmission of the said segmented message by transmitting the message transfer request primitive to the MTP.

The signal network management message is a “transfer allowed” message, and preferably includes the routing label parameter containing the message sender/receiver signal point information, the heading code parameter distinguishing the signal message, the signal point parameter indicating the information on the signal point to which the message transmission is permitted, and the parameter indicating the maximum message size that may be processed.

Also, the signal network management message is a “traffic restart allowed” message, and preferably includes the routing label parameter containing the message sender/receiver signal point information, the heading code parameter distinguishing the signal message, the signal point parameter indicating the information on the signal point to which the message transmission is permitted, and the parameter indicating the maximum message size that may be processed.

The method of including the maximum message size information in the signal point availability information primitive in step (b) is to add the maximum message size parameter to the said signal point availability information primitive.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram illustrating the structure of a related art No. 7 signal network;

FIG. 2 is a diagram illustrating the structure of the MTP of FIG. 1;

FIG. 3 is a diagram illustrating the structure of a related art No. 7 signal network in which narrowband signal points and broadband signal points are connected to each other;

FIG. 4 is a diagram illustrating the internal protocol structure of a narrowband signal point;

FIG. 5 is a diagram illustrating the internal protocol structure of a broadband signal point;

FIG. 6 is a diagram illustrating the internal protocol structure of a mixed MTP signal point;

FIG. 7 is a diagram illustrating the message transmission path via a mixed MTP signal point between a narrowband signal point and a broadband signal point;

FIG. 8a is an illustration of the specific format of a modified “transfer allowed” message according to te preferred embodiment;

FIG. 8b is an illustration of the specific format of a modified “traffic restart allowed” message according to the preferred embodiment;

FIG. 9 is an illustration of a modified signal point availability information primitive according to the preferred embodiment; and

FIG. 10 is a flow chart illustrating the MTP user part's signal message segment process and the process of the signal message transmission request to the MTP according to the preferred embodiment.

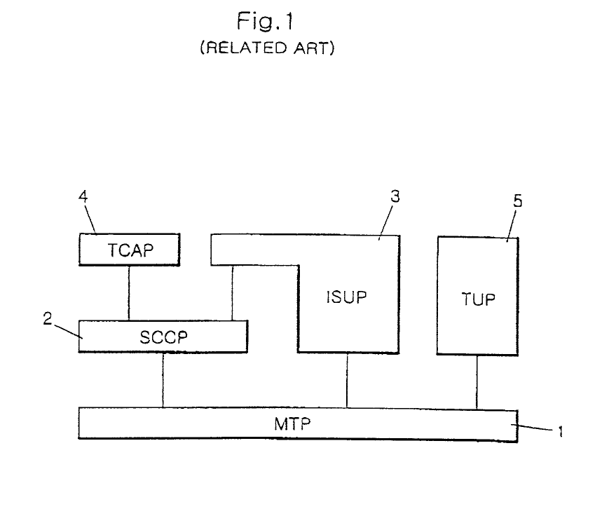

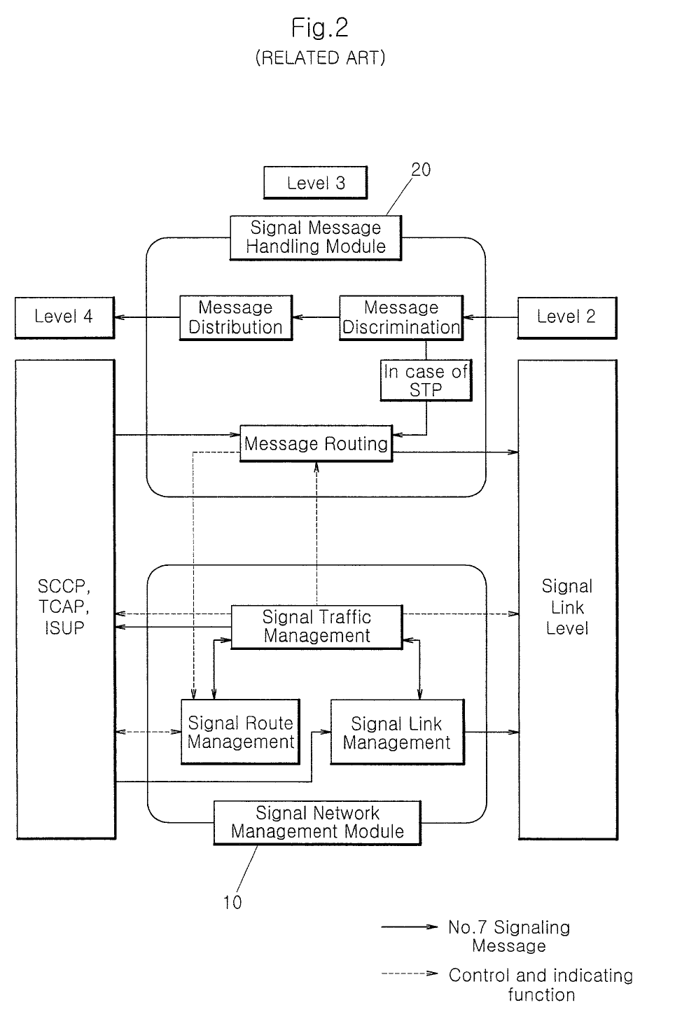

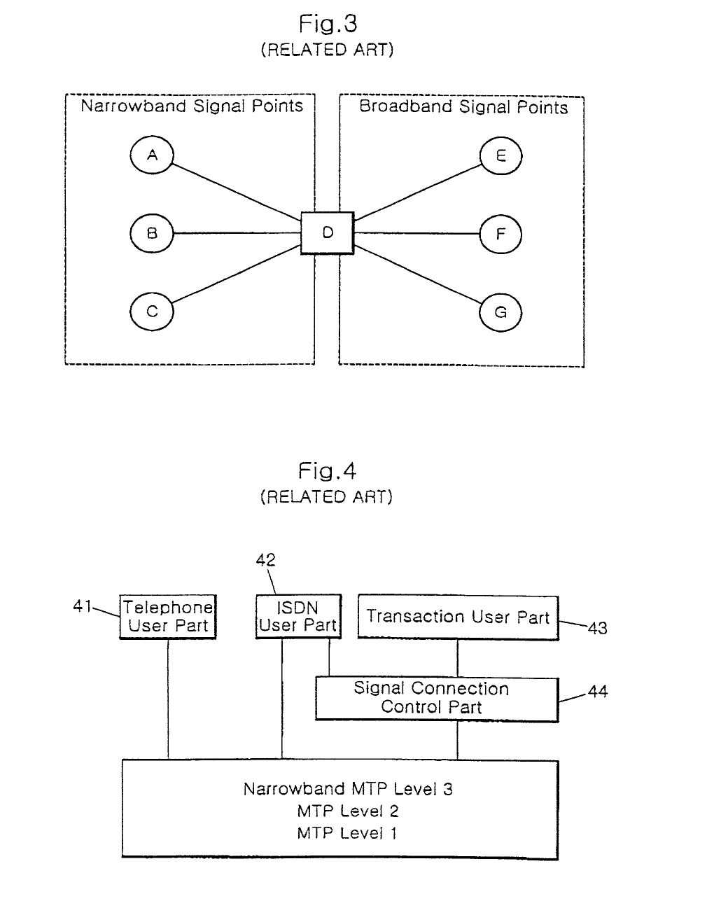

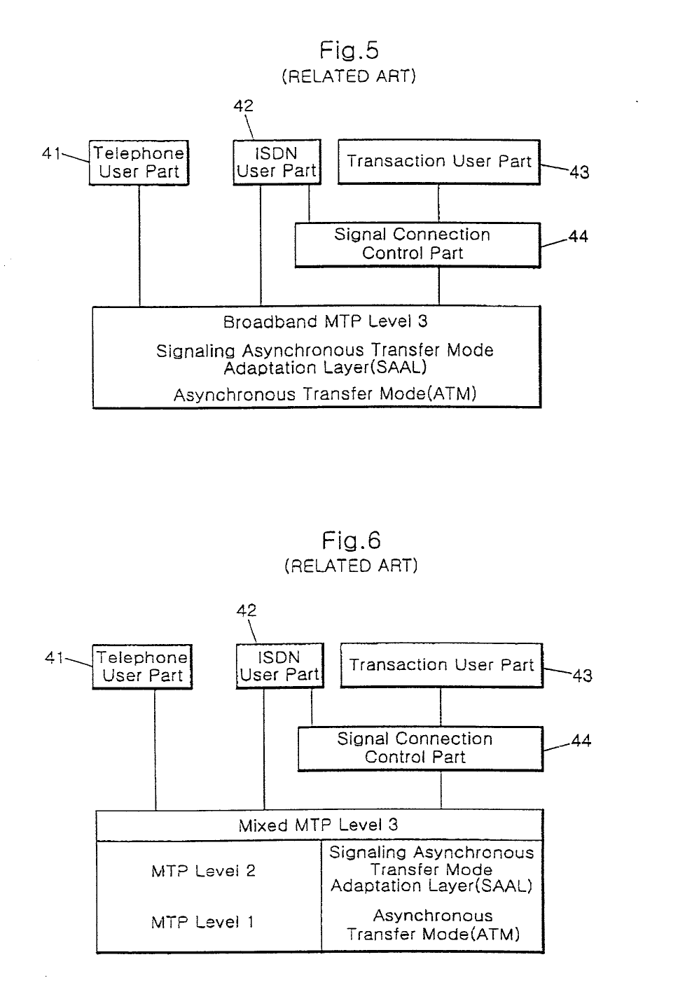

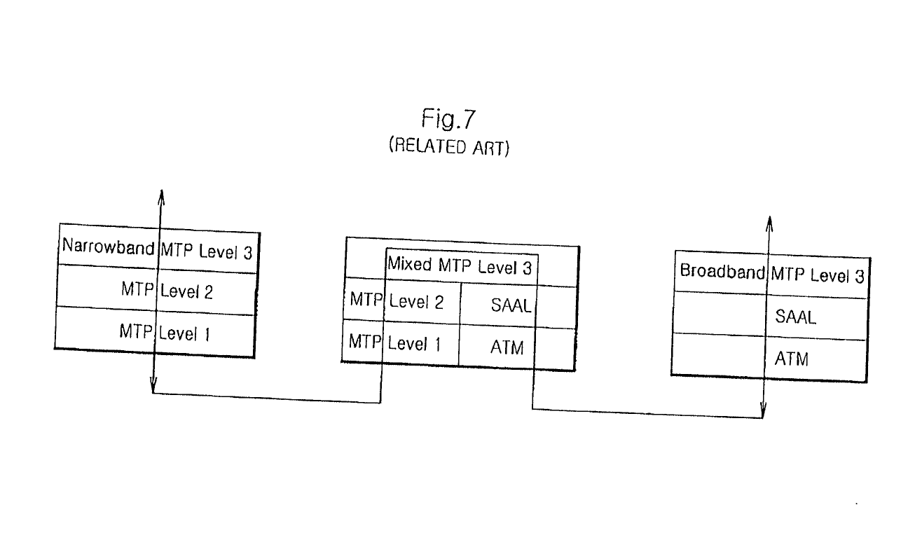

### DETAILED DESCRIPTION OF PREFERRED EMBODIMENTS

The preferred embodiment of the present invention provides a method of including a parameter regarding the maximum message size in the “transfer allowed” message and the “traffic restart allowed” message. By including this parameter, information regarding the maximum message size that each signal point may process in a signal network containing narrowband signal points and broadband signal points including No. 7signal points is transmitted to other signal points.

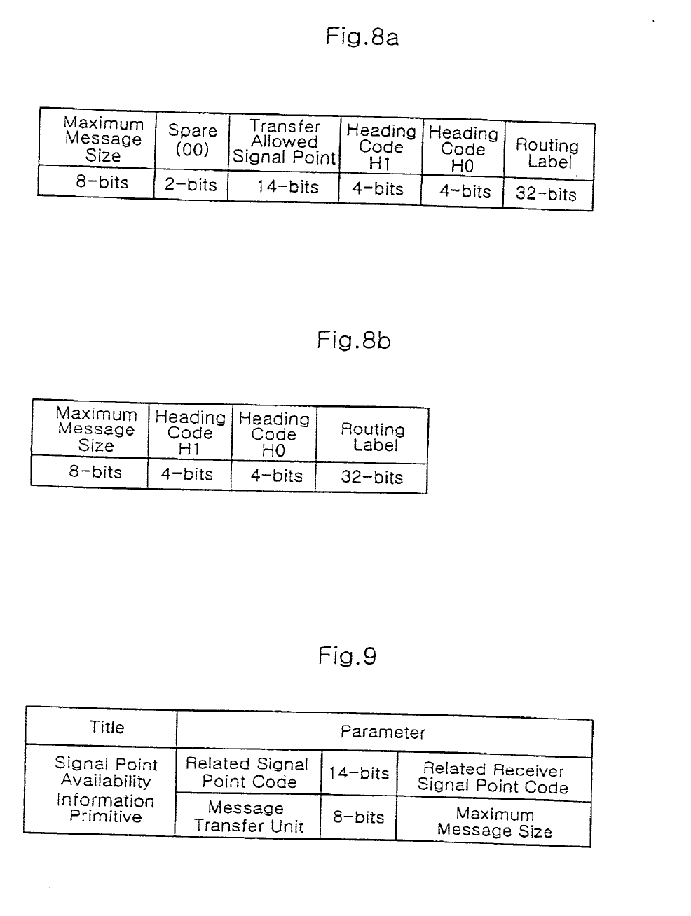

FIG. 8a illustrates the preferred format of a modified “transfer allowed” message and FIG. 8billustrates the preferred format of a modified “traffic restart allowed” message.

The “transfer allowed” message is issued by each signal point to inform the related signal points that the particular signal point itself or the adjacent signal points may receive messages. The modified “transfer allowed” message illustrated in FIG. 8a includes a routing label parameter containing the message sender/receiver signal point information and a heading code parameter, which is an identifier distinguishing the signal message having a value as defined in the recommendation ITU-T, Q.704. The transfer allowed message further contains the “transfer allowed” signal point parameter, which indicates that the message transfer is allowed, and the maximum message size parameter, which indicates the maximum message size that may be processed.

By transmitting the modified “transfer allowed” message, including the maximum message size parameter, to other related signal points, the transmitting signal point notifies each related signal point that receives the message of the maximum message size of the transmitting signal point.

In the event that a specific signal point that was previously inaccessible becomes accessible again, a “traffic restart allowed” message is used to notify the related signal points that the message transfer can be resumed. As with the “transfer allowed” message, the “traffic restart allowed” message illustrated in FIG. 8b includes a maximum message size parameter in addition to other conventional parameters. The maximum message size parameter indicates the maximum message size that may be processed by the relevant signal point. The conventional parameters include the heading code parameter, which is an identifier used to distinguish the signal message, and the routing label parameter, which contains the message sender/receiver signal point information.

By transmitting the modified “traffic restart allowed” message, including the maximum message size parameter, to other related signal points, the transmitting signaling point notifies each related signal point that receives the message of the maximum message size of the transmitting signal point.

In either case, the signal may be transmitted through a route established directly between the two relevant signal points, or through an indirect route in which the signal is transmitted via other signal points. In particular, when a message is transferred from a broadband signal point to a narrowband signal point or vice versa, a mixed MTP signal point must be used for the message transfer. In such event, the “transfer allowed” message or the “traffic restart allowed” message is transmitted not only to the message's destination signal point, but also to all signal points through which the message passes.

The MTP user part stores the maximum message size information of the received “traffic restart allowed” message in a database. According to the preferred embodiment, the MTP also stores the maximum message size information in a database, and when the MTP user part requests the message transfer, the MTP checks whether the correct message size has been set for the transmission request.

According to the preferred embodiment, it is preferable that the “transfer allowed” message and the “traffic restart allowed” message be transmitted both as a part of the signaling network management procedure, and also when the maximum message size of a particular signal point is changed.

The MTP of each signal point that receives the “transfer allowed” message or the “traffic restart message” from the signal network preferably transfers the signal point accessibility information to the MTP user part using a signal point availability information primitive (MTP-RESUME.indication primitive). In order to include the signal point's maximum message size information in the signal point accessibility information to be transmitted, the signal point availability information primitive is also modified.

FIG. 9 illustrates the format of the modified signal point availability information primitive according to the preferred embodiment. As shown in FIG. 9, the modified primitive includes the maximum message size parameter, as well as other conventional related signal points' code parameters. When receiving the “transfer allowed” message, the MTP of the signal point immediately transmits the signal point availability information primitive to the MTP user part. In contrast, when the MTP of the signal point receives the “traffic restart allowed” message, the MTP transmits the signal point availability information primitive to the MTP user part only after the signal point restart procedure between the receiving point which transmitted the “traffic restart allowed” message and its own signal point is completed.

If more than one signal route have been established, the signal point availability information primitive still includes only one parameter for maximum message size information concerning a particular signal point. Thus, if there are many routes and if the maximum message size is different for each of these routes, the route with the smallest maximum message size is identified. The smallest maximum message size is thus set as the maximum message size of the signal point availability information primitive and is transmitted as such.

If another route is newly established and the maximum message size of the new route is smaller than the previous maximum message size, the maximum message size information of the newly established route is transmitted to the related signal points through the signal network management message as described above. The MTP user part and the MTP of the signal point that receives the maximum message size information store the updated maximum message size information in the database.

Through the received signal point availability information primitive, the MTP user part will be provided with the maximum message size that can be processed by the signal point that sent the “transfer allowed”message or the “traffic restart allowed”message. Using the maximum message size information, the MTP user part then transmits a MTP transfer request primitive (MTP-Transfer.request primitive). The MTP-transfer request primitive is used to request the transfer of the signal message. In other words, when a message is to be transferred to a particular signal point, the MTP user part refers to the maximum message size of that particular signal point. If the size of the message to be transferred is larger than the maximum message size that can be processed by the signal point, the MTP user part segments the message and transmits the segmented message. Otherwise, the MTP user part transmits the message to the signal point without any segmenting process.

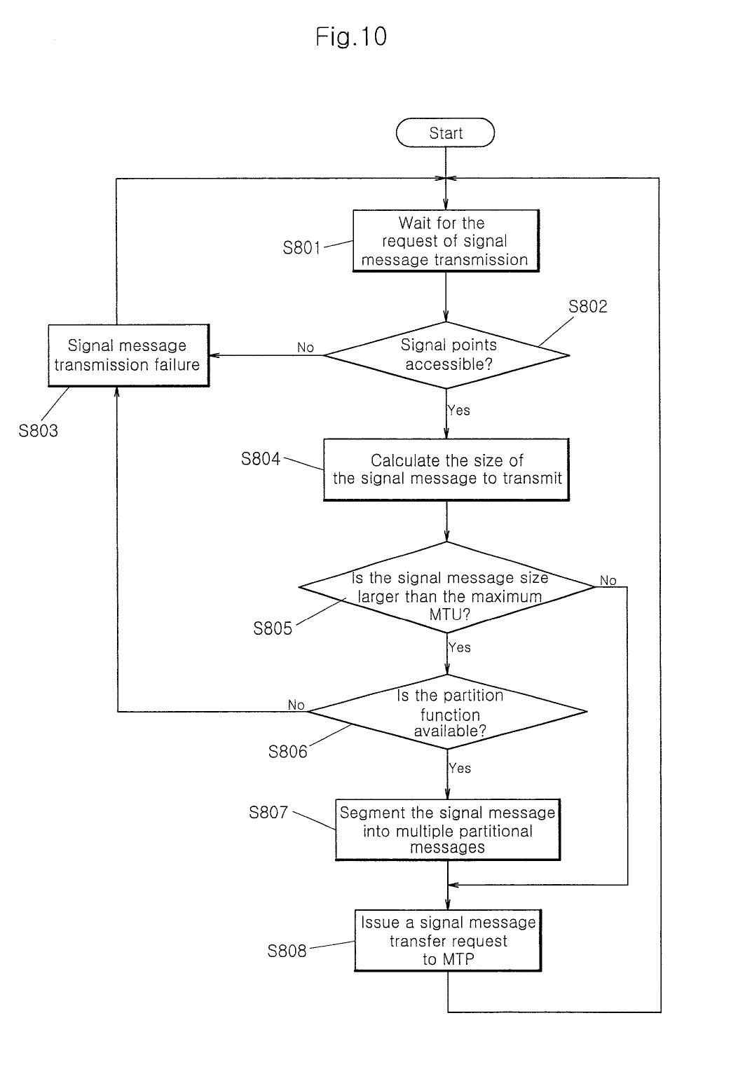

FIG. 10 is a diagram illustrating the procedures of the signal message transfer request to the MTP including the MTP user part's signal message segmenting process, according to a preferred embodiment. As shown in FIG. 10, the MTP user part first waits for the signal message transmission request (S801). In the waiting state, if there is any request for the signal message transmission, it is determined whether the signal point which is to receive the message is currently accessible (S802). The signal point's accessibility is determined through the signal point availability information primitive received from the MTP.

If the signal point is inaccessible, the process for the signal message transmission failure is conducted (S803) and the process returns to waiting for a new signal message transmission request (S801). If the signal point is accessible, the maximum message size of the signal point is calculated based upon the information obtained from the modified signal point availability information primitive, as shown in FIG. 9 (S804).

After the maximum message size of the destination signal point is calculated, the calculated maximum message size is compared to the size of the message to be transmitted (S805). This is done to determine whether the maximum message size is larger than the message to be transmitted.

If the maximum message size of the destination signal point is larger than the message to be transmitted, the message may be transmitted without any additional segmenting process. Thus, the signal message transfer request is made by transmitting the MTP transfer request primitive to the MTP (S808). The process then moves back to waiting for a new message transmission request (S801).

If, however, the maximum message size of the destination signal point is smaller than the message to be transmitted, the message is preferably segmented at the MTP user part. Otherwise, the message sent without segmenting would be abandoned. To perform the segmenting, it is determined whether the MTP user part supports the message segmenting function (S806).

If the MTP user part does not provide the message segmenting function, the message cannot be transferred. Thus, the step for the signal message transmission failure is conducted (S803), and the process returns to waiting for a new signal message transmission request (S801). If the MTP user part supports the signal message segmenting function, the message is divided into multiple segmented messages so that the message unit to be transmitted is not be larger than the maximum message size of the destination signal point (S807). After the message is segmented, the MTP user part requests the transmission of the segmented signal messages by sending the MTP transfer request primitive to the MTP (S808). Then, the process moves back to waiting for a new signal message transmission request (S801).

The method for managing a signal network having a mixed MTP signal point according to the preferred embodiment have many advantages. For example, if a message is transferred via a mixed MTP signal point in the signal network containing broadband signal points and narrowband signal points, the information concerning the message size that each signal point may process is shared. Thus, when a message of the size larger than the maximum message size that may be processed is to be transmitted, the message is transferred by using the MTP user part message segmenting function. Consequently, signal message abandonment caused by the limitation on the message size is avoided. Furthermore, the reliability and the effectiveness of the signal network are enhanced accordingly.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for managing a signal network having a mixed MTP signal point, comprising:
including information on a maximum message size that a first signal point may process in a signal network management message; and
determining the maximum message size of the first signal point to which a signal is to be transmitted by at least one second signal point in accordance with the signal network management message.

2. The method of claim 1, wherein the signal network management message is a transfer allowed message.

3. The method of claim 2, wherein the transfer allowed message comprises a routing label parameter, to indicate signal point information of the message sender/receiver, a heading code parameter, to distinguish the message, a signal point parameter, to indicate the information on the signal point where the message transfer is allowed, and a size parameter, to indicate the maximum message size that may be processed.

4. The method of claim 1, wherein the signal network management message is a the signal traffic restart message.

5. The method of claim 3, wherein the signal traffic restart message comprises a routing label parameter, to indicate signal point information of the message sender/receiver, a heading code parameter, to distinguish the message, a signal point parameter, to indicate the information on the signal point where the message transfer is allowed, and a size parameter, to indicate the maximum message size that may be processed.

6. The method of claim 1, further comprising:
transmitting the signal network management message to MTPs of the at least one second signal point; and
transmitting the maximum message size information included in the transmitted message to MTP user parts associated with each of the MTPs.

7. The method of claim 6, wherein the maximum message size information is transmitted from the MTP to the MTP user part, as part of a signal point availability information primitive.

8. The method of claim 6, further comprising storing the received maximum message size information in a database of each of the MTPs.

9. The method of claim 6, further comprising storing the received maximum message size information in a database of each of the MTP user parts.

10. The method of claim 6, wherein the at least one second signal point determines the maximum message size of the first signal point in accordance with a message size parameter in the signal network management message.

11. The method of claim 10, wherein the at least one second signal point segments messages addressed to the first signal point where a size of the messages exceeds the maximum message size of the first signal point, and wherein each segment does not exceed the maximum message size.

12. The method of claim 1, wherein the signal network management message is transmitted to the at least one second signal point whenever there is a change in the maximum message size that may be processed by the first signal point.

13. The method of claim 1, wherein if more than one signal routes have been established, a message processing capacity of the route with a smallest maximum message size among the more than one signal route is determined to be the maximum message size of the first signal point.

14. The method of claim 1, further comprising comparing the determined maximum message size and a size of a message to be transmitted, and segmenting the message for transmission if the message to be transmitted is larger than the determined maximum message size.

15. The method of claim 14, wherein the step of comparing the message sizes and segmenting the message comprises:
comparing the maximum message size of the signal point to which the message is to be transmitted with the size of the message to be transmitted;
if the size of the message to be transmitted is smaller than the maximum message size of the signal point to which the message is to be transmitted, requesting transmission of the message from the MTP user part to the MTP;
if the size of the message to be transmitted is larger than the maximum message size of the signal point to which the message is to be transmitted; segmenting the message to be transmitted at the MTP user part; and
requesting transmission of the segmented message from the MTP user part to the MTP.

16. The method of claim 15, wherein the request for transmission from the MTP user part to the MTP is made by transmitting a MTP message transfer request primitive.

17. A method for managing a signal network having a mixed MTP signal point, comprising:
(a) including information concerning a maximum message size that a first signal point may process in a signal network management message, and transmitting the signal network management message to at least one other signal point;
(b) when a MTP receives the signal network management message transmitted in step (a) including the maximum message size information in a signal point information primitive based upon the received signal network management message, and transmitting the signal point information primitive to a MTP user part;
(c) determining whether the first signal point is available for message transmission based upon the signal point information primitive received in step (b) and comparing the maximum message size of the first signal point with a size of a message to be transmitted;
(d) if the size of the message to be transmitted is smaller than the maximum message size of the first signal point, requesting transmission of the message by transmitting a message transfer request primitive to the MTP; and
(e) if the size of the message to be transmitted is larger than the maximum message size of the first signal point, segmenting the message to be transmitted at the MTP user part and requesting transmission of the segmented message by transmitting the message transfer request primitive to the MTP.

18. The method of claim 17, wherein the signal network management message is a message allowing the transfer, and comprises a routing label parameter indicating the message's sender/receiver signal point information, a heading code parameter distinguishing the signal message, a signal point parameter indicating the information on the signal point where the message transfer is allowed, and a size parameter indicating the maximum message size that may be processed.

19. The method of claim 17, wherein the signal network management message is a message allowing the signal traffic restart, and comprises a routing label parameter indicating the message's sender/receiver signal point information, a heading code parameter distinguishing the signal message, a signal point parameter indicating the information on the signal point where the message transfer is allowed, and a size parameter indicating the maximum message size that may be processed.

20. The method of claim 17, wherein if more than one signal route have been established, the message processing capacity of a route with a smallest maximum message size among the more than one signal route is determined to be the maximum message size of the first signal point.

21. The method of claim 17, wherein the signal network management message is transmitted whenever there is any change in the size of the message that may be transferred to a signal point.

22. The method of claim 21, wherein the signal network management message is further transmitted in accordance with conventional signaling network management procedures.

23. The method of claim 17, wherein the maximum message size information is included in the signal point availability information primitive by adding the maximum message size parameter to the signal point availability information primitive.

24. The method of claim 17, wherein the maximum message size is stored in a database of at least one of the MTP and the MTP user part.

25. A common channel signaling system, comprising:
first and second signaling points; and
a mixed MTP signaling point coupled between the first and second signaling points, wherein each of the first and second signaling points can be an origination signaling point and a destination signaling point, and wherein the origination signaling point is configured to segment a first message for transmission to the destination signaling point if the first message exceeds a maximum message size of the destination signaling point.

26. The system of claim 25, wherein the origination signaling point determines whether the first message exceeds the maximum message size of the destination signaling point based on a control message sent from the destination signaling point.

27. The system of claim 26, wherein the control message is one of a transfer allowed massage and a transfer restart allowed message, and wherein the control message contains a parameter indicating the maximum message size of destination signaling point.

28. This system of claim 25, wherein the origination signaling point transmits the first message to the destination signaling point without segmentation if the message does not exceed the maximum message size of the destination signaling point.

29. The system of claim 25, wherein the first message is segmented into a plurality of second messages, each of the plurality of second messages not exceeding the maximum message size of the destination signaling point.

30. A message to indicate a maximum receivable message size of a signaling point in a common channel signaling system, comprising:
a routing label parameter for message sender and receiver signal point information;
a heading code parameter for distinguishing the message as a signal message; and
a maximum message size parameter for indicating a maximum message size that can be processed by the signal point sending the message.

31. The message of claim 30, further comprising a transfer allowed signal point parameter to indicate that transfer message transfer is allowed.

32. The message of claim 30, wherein data from the maximum message size parameter is stored in a database of a MTP of a signaling point receiving the message.

33. The message of claim 30, wherein data from the maximum message size parameter is included in a signal point availability primitive of a signaling point receiving the message.
